(19) United States
(12) Patent Application Publication
(10) Pub. No.: US 2008/0232266 A1
(43) Pub. Date: Sep. 25, 2008

(54) NETWORK MONITORING APPARATUS, NETWORK MONITORING METHOD AND RECORDING MEDIUM

(76) Inventors: Kouji JITSUI, Fukuoka (JP); Katsunari Togasaki, Fukuoka (JP); Masayoshi Kamada, Fukuoka (JP); Mitsuhiro Sato, Fukuoka (JP)

Correspondence Address: STAAS & HALSEY LLP, SUITE 700, 1201 NEW YORK AVENUE, N.W., WASHINGTON, DC, 20005, US

(21) Appl. No.: 12/044,534

(22) Filed: Mar. 7, 2008

(30) Foreign Application Priority Data
Mar. 20, 2007 (JP) 2007-072197

(51) Int. Cl. H04L 12/26

(52) U.S. Cl. 370/252

(57) ABSTRACT

A network monitoring apparatus that is in communication with a monitoring target apparatus through a network, receives traffic values transmitted from the monitoring target apparatus, accumulates the traffic values, calculates a traffic calculation value for judging congestion of the monitoring target apparatus by using the traffic values, and using a judgment target value corresponding to a traffic value as a congestion judgment target from the traffic values transmitted from the monitoring target apparatus and the traffic calculation value as a threshold value, compares the judgment target value and the threshold value. The apparatus judges whether the monitoring target apparatus is congested with traffic by using the comparison result.

### CROSS-REFERENCE TO RELATED APPLICATIONS

This application is related to and claims priority under 35 U.S.C §119(a) on Japanese Patent Application No. 2007-72197 filed on Mar. 20, 2007 in the Japan Patent Office, and incorporated by reference herein.

### BACKGROUND

1. Field

The embodiments relate to a network monitoring apparatus, a network monitoring method and a recording medium for recording a network monitoring program with which a traffic value of an apparatus as a traffic monitoring target is monitored to judge congestion.

2. Description of the Related Art

There is a case where congestion occurs due to increase of a traffic amount in an exchange, etc. which are connected to networks. Therefore, it is necessary to monitor the traffic amount of an exchange or the like which is connected to a network and judge accurate congestion by using the traffic value. For example, a network monitoring system for judging the congestion of a monitoring target apparatus by a network monitoring apparatus connected to the monitoring target apparatus is known as a system for judging the congestion of an exchange (the monitoring target apparatus for traffic).

The network monitoring apparatus comprises a traffic receiving function part, a traffic analyzing function part, a congestion judging function part, etc., for example. The traffic receiving function part receives traffic from a monitoring target apparatus. The traffic analyzing function part analyzes a received traffic value. The congestion judging function part judges occurrence of an alarm concerning congestion by using the traffic value. The network monitoring apparatus judges the congestion by using the traffic value received from the monitoring target apparatus and a fixed threshold value defined in advance, and outputs an alarm when a traffic value exceeding the fixed threshold value is notified from the monitoring target apparatus.

However, in such a network monitoring system, the threshold value serving as a condition for outputting an alarm is defined in advance. Therefore, when the trend of the traffic value varies and thus consistency is not established between the traffic value and the threshold value, this network monitoring system cannot judge the accurate congestion. In order to perform an accurate congestion judgment in the network monitoring system even when the trend of the traffic value varies, it is required to derive and re-define a threshold value. Therefore, there is a problem that this requirement directly causes the increase of quantity of work on operation.

Japanese Laid-open Patent Publication No. 2006-14329 (U.S. Patent No. 20050286416A1) discloses a technique of detecting congestion at a communication terminal of a transmission side from communication terminals among which data communications are carried out through a network, and changing congestion control parameters. The communication terminal at the transmission side estimates the rate of preferential traffic occupying the traffic in the network and changes a threshold value for detecting a congestion sign in accordance with the estimated rate.

In the technique described above, it is required to estimate the rate of preferential traffic occupying the traffic in the network, and thus the construction of the communication terminal is complicated. Furthermore, it is required to estimate the rate of preferential traffic at each communication terminal to detect congestion, so that the construction of the monitoring system for monitoring the network is also complicated.

### SUMMARY

According to an aspect of the embodiments an apparatus in communication with a monitoring target apparatus through a network has a traffic receiver that receives traffic values transmitted from the monitoring target apparatus, a traffic accumulator that accumulates the traffic values, a traffic calculator that calculates a traffic calculation value by using the accumulated traffic values, and a congestion judger that compares a judgment target value, corresponding to a traffic value as a congestion judgment target from the accumulated traffic values, with the traffic calculation value as a threshold value, and judges based upon the comparison whether the monitoring target apparatus is congested with traffic.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram of congestion judgment according to a first embodiment;

FIG. 2 is a functional block diagram of a network monitoring system according to the first embodiment;

FIG. 3 is a sequence diagram of operation procedures of a network monitoring apparatus according to the first embodiment;

FIG. 4 is a diagram of an example threshold value creating table;

FIG. 5 is a sequence diagram of the operation procedures of a network monitoring apparatus according to a second embodiment;

FIG. 6 is a table (1) of traffic value information and traffic calculation values;

FIG. 7 is a table (2) of traffic value information and traffic calculation values;

FIG. 8 is a functional block diagram of a network monitoring system according to a third embodiment;

FIG. 9 is a sequence diagram of operation procedures of a network monitoring apparatus according to a third embodiment;

FIG. 10 is a sequence diagram of operation procedures of a network monitoring apparatus according to a fourth embodiment;

FIG. 11 is a system construction diagram of a computer system according to another embodiment; and

FIG. 12 is a functional block diagram of a main body portion of the computer system shown in FIG. 11.

### DETAILED DESCRIPTION OF THE PREFERRED EMBODIMENTS

Detailed Description of the Embodiments

Preferred embodiments of a network monitoring apparatus and a network monitoring method will be described hereunder in detail with reference to the accompanying drawings. The present invention is not limited to the embodiments.

### First Embodiment

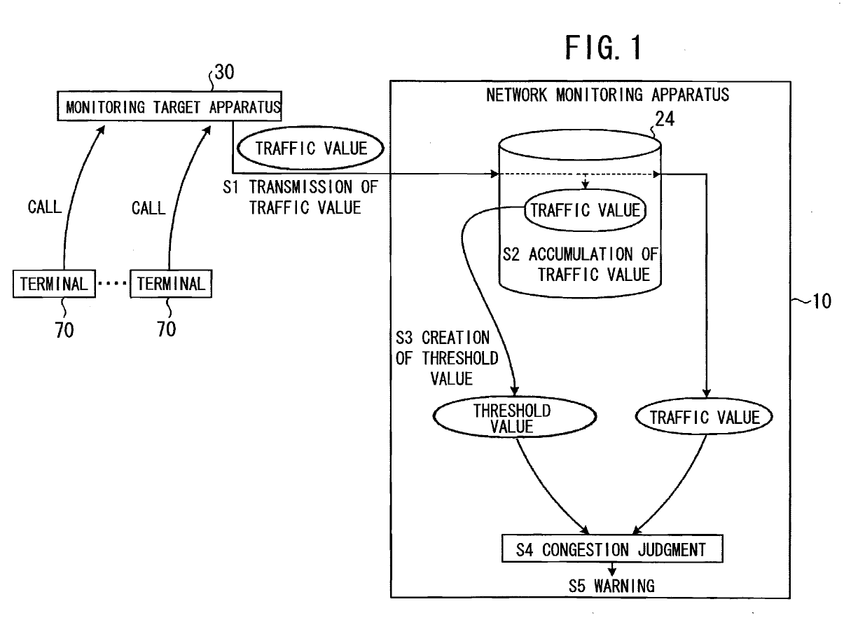

First, the concept of a congestion judgment according to an embodiment will be described. FIG. 1 is a diagram showing the concept of the congestion judgment according to a first embodiment. A monitoring target apparatus 30 as a traffic monitoring target is connected to a plurality of terminals 70 and executes communication processing with each terminal 70. The monitoring target apparatus 30 transmits information containing a traffic value to a network monitoring apparatus 10 at a predetermined timing (for example, every one minute) (S1).

In the network monitoring apparatus 10, the traffic value transmitted from the monitoring target apparatus 30 is accumulated in a traffic accumulator 24 (S2). Then, a threshold value used for the congestion judgment is created by using this traffic value (S3).

The network monitoring apparatus 10 receives plural traffic values transmitted from the monitoring target apparatus 30. The network monitoring apparatus 10 extracts a traffic value as a congestion judgment target from the plural received traffic values, and compares the extracted traffic value with the created threshold value to thereby make the congestion judgment of the monitoring target apparatus 30 (S4). Then, the network monitoring apparatus 10 gives warning concerning the congestion (S5) when the judgment result of the congestion judgment indicates a high probability of congestion.

The network monitoring apparatus 10 may use an average value of accumulated plural traffic values or the like as the traffic value as the congestion judgment target. As described above, according to this embodiment, the traffic value as the congestion judgment target from the traffic values transmitted from the monitoring target apparatus 30 may be set to the average value of plural traffic values which have been accumulated just before. Furthermore, previously accumulated traffic values may be used as the threshold value for the congestion judgment. The congestion judgment is made by using the thus-obtained traffic value and threshold value.

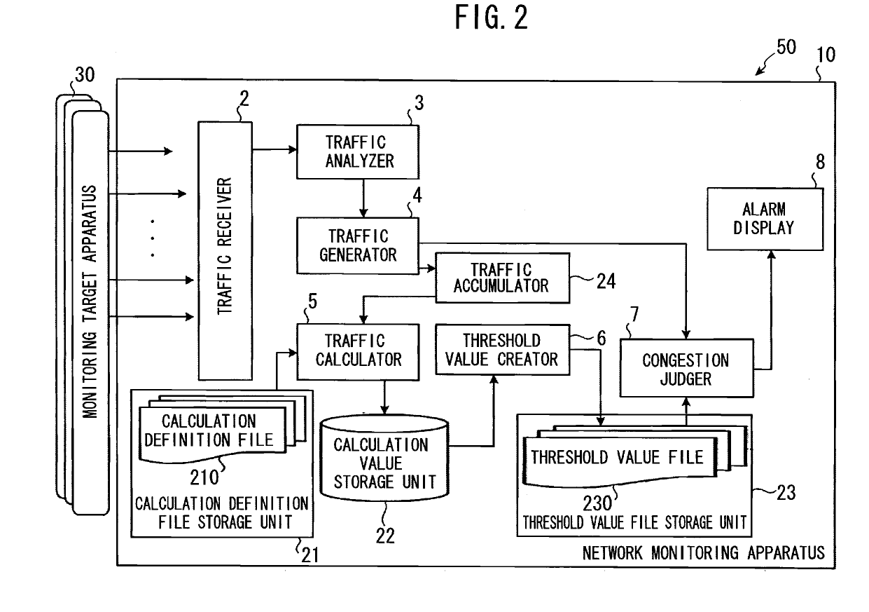

FIG. 2 is a block diagram showing the construction of a network monitoring system according to the first embodiment. The network monitoring system 50 includes the network monitoring apparatus 10 and one or plural monitoring target apparatuses 30.

The monitoring target apparatus 30 is an apparatus such as an exchange as a traffic monitoring target or the like. The monitoring target apparatus 30 is connected to various kinds of communication terminals through a predetermined communication network. Each monitoring target apparatus 30 is connected to the network monitoring apparatus 10. Each monitoring target apparatus 30 stores an obtained traffic value into a traffic file as a binary file, and transmits a traffic value as a congestion judgment target to the network monitoring apparatus 10 at a predetermined timing.

The network monitoring apparatus 10 calculates the traffic value of each monitoring target apparatus 30 from a traffic file transmitted from each monitoring target apparatus 30, and judges the congestion by using the calculated traffic value.

The network monitoring apparatus 10 includes a traffic receiver 2, a traffic analyzer 3, a traffic generator 4, a traffic calculator (calculating unit) 5, a threshold value creator 6, a congestion judger 7, an alarm display 8, a calculation definition file storage unit 21, a calculation value storage unit 22, a threshold value file storage unit 23 and a traffic accumulator 24.

The traffic receiver 2 is connected to the traffic analyzer 3. The traffic analyzer 3 is connected to the traffic generator 4. The traffic generator 4 is connected to the congestion judger 7 and the traffic accumulator 24. Furthermore, the traffic calculator 5 is connected to the traffic accumulator 24, the calculation definition file storage unit 21 and the calculation value storage unit 22. The threshold value creator 6 is connected to the calculation value storage unit 22 and the threshold value file storage unit 23. Furthermore, the congestion judger 7 is connected to the traffic generator 4, the threshold value file storage unit 23 and the alarm display 8.

The traffic receiver 2 receives the traffic file (the traffic value, etc.) of each monitoring target apparatus 30 from each monitoring target apparatus 30 at a predetermined timing, and inputs the traffic file into the traffic analyzer 3.

The traffic analyzer 3 analyzes where an item concerning traffic (traffic value) is put in the traffic file, and also extracts the item concerning the traffic. The traffic analyzer 3 inputs the thus-analyzed (extracted) item concerning the traffic as traffic value information into the traffic generator 4.

The traffic generator 4 first replaces the traffic value information transmitted from the traffic analyzer 3 with an XML (Extensible Markup Language) file, a CSV (Comma Separated Values) file or the like. By this replacement, the traffic generator 4 converts the traffic value information to such a format which enables the traffic value information to be handled by the network monitoring apparatus 10. The traffic generator 4 inputs the traffic value information generated through the replacement to the congestion judger 7 and the traffic accumulator 24. The traffic accumulator 24 is a storage unit such as a memory or the like for accumulating the traffic value information from the traffic generator 4.

Traffic values (past traffic values) are temporarily accumulated in the traffic accumulator 24. The calculation definition file storage unit 21 stores calculation definition files (calculation definition information) 210 of the traffic values. In the calculation definition file 210 are defined the item name of traffic as a calculation target, a calculation method of a calculation value using a traffic value (hereinafter referred to as traffic calculation value), etc. The traffic item name is traffic type and item information such as a calling number, a packet calling number, etc.

The traffic calculator 5 first extracts or determines from the traffic value information of the traffic accumulator 24, the traffic item name, the calculation method of the traffic calculation value, etc. as defined in the calculation definition file 210. The traffic calculator 5 further calculates the traffic calculation value according to the calculation method of the traffic calculation value. The calculation value of the traffic value corresponding to the calculation definition file 210 is used when the congestion is judged in the monitoring target apparatus 30. The traffic calculator 5 stores the traffic calculation value in the calculation value storage unit 22. The calculation value storage unit 22 is a storage unit such as a memory or the like for storing the traffic calculation value.

The threshold value creator 6 creates a threshold value for the congestion judgment by using the traffic calculation value in the calculation value storage unit 22. For example, the threshold value creator 6 adds the traffic calculation value with a value (congestion reference value) serving as a reference for the congestion judgment to create a threshold value used for the congestion judgment. The threshold value creator 6 stores the congestion reference value in advance. The threshold value file storage unit 23 is a storage unit such as a memory or the like for storing a threshold value file 230 which associates the threshold value created by the threshold creator 6 with the alarm content corresponding to the congestion judgment.

The congestion judger 7 receives the traffic value of the traffic value information transmitted from the traffic generator 4 (the present traffic value) (a normal traffic value described later). The threshold value File storage unit 23 stores the threshold values in the threshold value files 230. The congestion judger 7 makes the congestion judgment with respect to each item as a congestion judgment target by using the traffic value and the threshold value. The congestion judger 7 transmits an alarm generating instruction or a recovery (alarm stop) instruction as a judgment result of the congestion judgment to the alarm display 8.

The alarm display 8 is a display unit which is constructed to contain a liquid crystal monitor, an alarm lamp or the like, and the alarm display 8 displays information concerning an alarm based on the judgment result of the congestion judgment. The alarm display 8 displays information representing the generation of an alarm or the recovery and the content thereof as an alarm display concerning the congestion, whereby the alarm display 8 notifies a warning concerning the congestion to a user (maintenance person).

Next, the operation procedure of the network monitoring apparatus according to the first embodiment will be described.

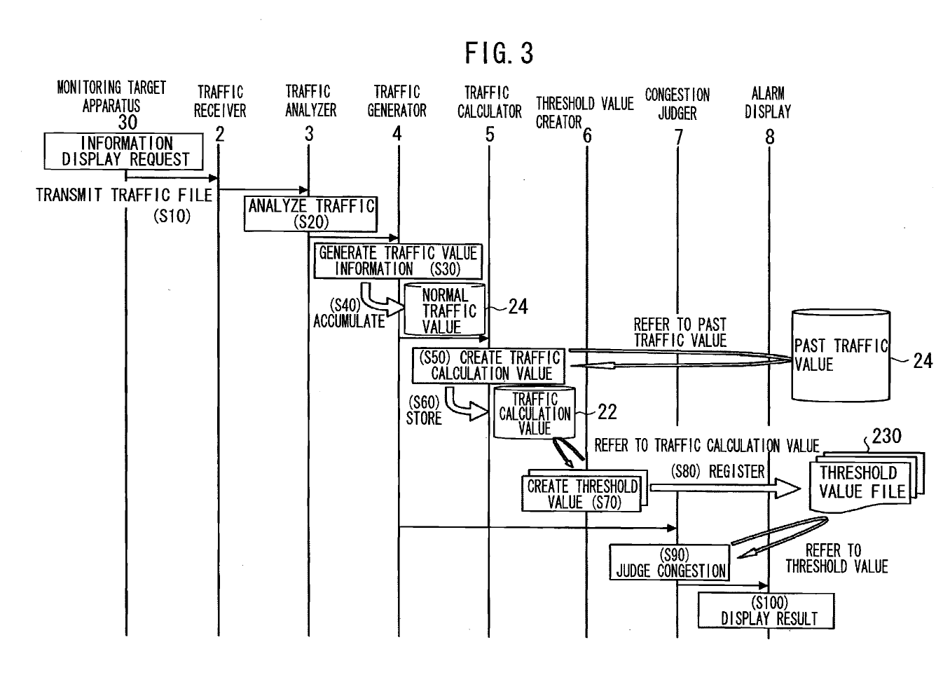

FIG. 3 is a sequence diagram showing the operation procedure of the network monitoring apparatus according to the first embodiment. In the network monitoring system 50, each monitoring target apparatus 30 transmits a traffic file containing a traffic value as an information display request concerning congestion to the network monitoring apparatus 10 at a predetermined timing (S10). The predetermined timing may be set to a fixed period, for example, every one minute, every three minutes or the like.

The traffic receiver 2 of the network monitoring apparatus 10 receives a traffic file of each monitoring target apparatus 30 from each monitoring target apparatus 30, and inputs it to the traffic analyzer 3. The traffic analyzer 3 analyzes the traffic file and extracts traffic value information (the traffic value, etc.) (S20). The traffic analyzer 3 inputs the extracted traffic value information to the traffic generator 4.

The traffic generator 4 replaces the traffic value information transmitted from the traffic analyzer 3 with an XML file, a CSV file or the like. By this replacement, the traffic generator 4 converts the traffic value information to such a format that the traffic value information can be handled in the network monitoring apparatus 10. Through this operation, the traffic generator 4 generates the traffic value information for its own apparatus (S30). The traffic generator 4 inputs the traffic value information replaced by the XML file, the CSV file or the like into the congestion judger 7 and the traffic accumulator 24. In this case, the traffic generator 4 inputs the traffic value information replaced by the XML file, the CSV file or the like as a normal traffic value into the congestion judger 7 and the traffic accumulator 24.

The traffic accumulator 24 accumulates the traffic value information from the traffic generator 4 (S40). In this case, the traffic accumulator 24 accumulates new traffic value information while adding the new traffic value information to the traffic value information which has been already accumulated. For example, the traffic accumulator 24 accumulates as new past traffic values (new traffic value information) the addition result obtained by adding the normal traffic value to the traffic values (past traffic values) which have been already accumulated.

Subsequently, the traffic calculator 5 refers to the traffic value information (past traffic values) of the traffic accumulator 24. The traffic item name, the calculation method of the traffic calculation value, etc. are defined in the calculation definition file 210 of the calculation definition file storage unit 21. The traffic value information is accumulated in the traffic accumulator 24. The traffic calculator 5 extracts the traffic item name and the traffic calculation value calculating method from the accumulated traffic value information of the traffic accumulator 24, based upon the calculation definition file 210. Then, the traffic calculator 5 calculates the traffic calculation value based upon the accumulated traffic value information by using the traffic calculation value calculating method in the calculation definition file 210. In other words, the traffic calculator 5 creates the traffic calculation value by using the previously received traffic values. In this case, the traffic calculator 5 creates the traffic calculation value by using the traffic calculation value calculating method corresponding to the traffic item name defined in the calculation definition file 210 from the traffic values stored in the traffic accumulator 24 (S50).

The traffic calculator 5 stores the calculated traffic calculation value and the traffic item name in association with each other in the calculation value storage unit 22. Accordingly, the calculation value storage unit 22 preserves and stores the traffic calculation value calculated by the traffic calculator 5 (S60).

Subsequently, the threshold value creator 6 refers to the traffic calculation value in the calculation value storage unit 22. The threshold value creator 6 creates the threshold value for the congestion judgment by using the traffic calculation value in the calculation value storage unit 22. The threshold value creator 6 adds the traffic calculation value with the congestion reference value to create the threshold value (S70).

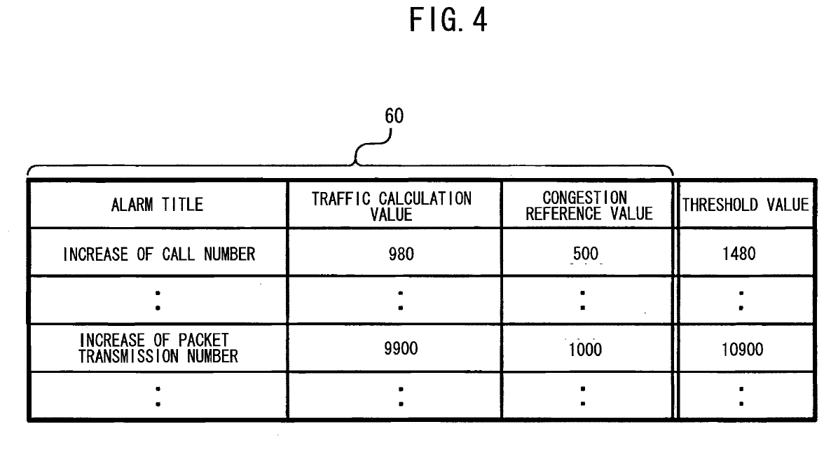

The method of creating the threshold value in this case will be described. The threshold creator 6 creates the threshold value by using a threshold value calculation table stored by the threshold value creator 6. FIG. 4 is a diagram showing an example of the construction of a threshold value creating table. The threshold value creating table 60 is an information table in which “traffic calculation value”, “congestion reference value” and an alarm name (alarm title) corresponding to the congestion judgment as calculation sources of the threshold value are associated with one another.

The “traffic calculation value” is a traffic calculation value stored by the calculation value storage unit 22. The “congestion reference value” is a congestion reference value which is preset in the threshold value creator 6. The “alarm title” is the warning corresponding to the threshold value calculated by using the “traffic calculation value” and the “congestion reference value”, and also it is the content of a warning displayed (output) with the calculated threshold value as a reference. The “alarm title” corresponds to the traffic item name (the number of calls (hereinafter referred to as “call number”), the number of packet calls (hereinafter referred to as “packet call number”)) of the traffic value information as the calculation source of the “traffic calculation value”.

The threshold value creator 6 extracts the traffic calculation value corresponding to the “alarm title” (traffic item) from the calculation value storage unit 22 to calculate the threshold value used for the congestion judgment. The threshold creator 6 adds the extracted “traffic calculation value” and the “congestion reference value” to calculate the “threshold value”. As described above, the threshold value creator 6 creates threshold value on the basis of the traffic values (traffic calculation values) which were received previously. Therefore, it is possible to create the threshold value corresponding to the trend of the variation of the traffic value. Furthermore, the threshold value is created by using the “congestion reference value”, and thus the proper threshold value which is matched with the type of the congestion judgment (the traffic item or the like) can be easily set.

For example, when the “traffic calculation value” is equal to 980 and the “congestion reference value” is equal to 500, the “threshold value” is equal to 1480. In this case, this threshold value is used for the congestion judgment (alarm) with respect to the increase of the number of calls (i.e., call number).

The threshold value creator 6 extracts the “alarm title” corresponding to the created threshold value from the threshold value creating table 60, and associates the extracted “alarm title” with the “threshold value”. The threshold value creator 6 registers the file containing the associated “alarm title” and “threshold value” as a threshold value file 230 into the threshold value file storage unit 23 (S80).

The threshold value creator 6 may extract the traffic item name corresponding to the created threshold value from the calculation value storage unit 22, and set the alarm content corresponding to the threshold value (the alarm concerning the call number, the packet call number or the like) on the basis of the extracted traffic item name. Accordingly, even when no “alarm title” is set in the threshold value creating table 60, the threshold value creator 6 can register into the threshold value file storage unit 23 the threshold value file 230 in which the created threshold value and the alarm content corresponding to the congestion judgment are associated with each other.

Subsequently, the congestion judger 7 refers to the threshold value of the threshold value file storage unit 23 (the threshold value file 230). The congestion judger 7 compares the traffic value information transmitted from the traffic generator 4 (the normal traffic value) with the threshold value stored in the threshold value file storage unit 23, and makes the congestion judgment every traffic item (every alarm content) as a congestion judgment target (S90). The normal traffic value in this case corresponds to the judgment target value in the claims.

When the traffic value of the traffic value information is larger than the threshold value under no congestion state, the congestion judger 7 transmits to the alarm display 8 a judgment result of the congestion judgment which indicates a large probability of the congestion. In the case of the high probability of the congestion, the congestion judger 7 transmits an output (occurrence) instruction of an alarm to the alarm display 8.

On the other hand, when the traffic value of the traffic value information is smaller than the threshold value under the congestion state, the congestion judger 7 transmits to the alarm display 8 a judgment result of the congestion judgment which indicates a small probability of the congestion. In the case of the small probability of the congestion, the congestion judger 7 transmits an alarm stop (recovery) instruction to the alarm display 8. The alarm display unit 8 executes an alarm display concerning the congestion (the alarm concerning the call number, the packet call number, etc.) on the basis of the instruction from the congestion judger 7 (S100).

As described above, in the first embodiment, the threshold value used for the congestion judgment is automatically generated in the network monitoring system (network monitoring apparatus 10), and thus it is unnecessary to define (set) the threshold value used for the congestion judgment in advance. Furthermore, the network monitoring system calculates the threshold value used for the congestion judgment by using past traffic values. Therefore, even when consistency is not established between the traffic value and the threshold value because of variation of the trend of the traffic value, it is unnecessary to re-define the threshold value, and a proper threshold value which complies with the trend (variation) of the traffic value can be calculated.

Furthermore, according to the network monitoring system, the traffic calculation value is calculated on the basis of the calculation definition file 210, and thus the traffic calculation value can be easily calculated. Furthermore, according to the network monitoring system, the traffic item name as a calculation target of the traffic calculation value is set in the calculation definition file 210. Therefore, in the network monitoring system, the traffic item name can be easily changed and added, and also the traffic calculation value which complies with the traffic item name can be easily calculated.

Accordingly, the working labor on the operation when the congestion judgment is executed on the monitoring target apparatus 30 can be reduced. Accordingly, it is possible to easily monitor the traffic value of the monitoring target apparatus and accurately judge the congestion with a simple construction.

### Second Embodiment

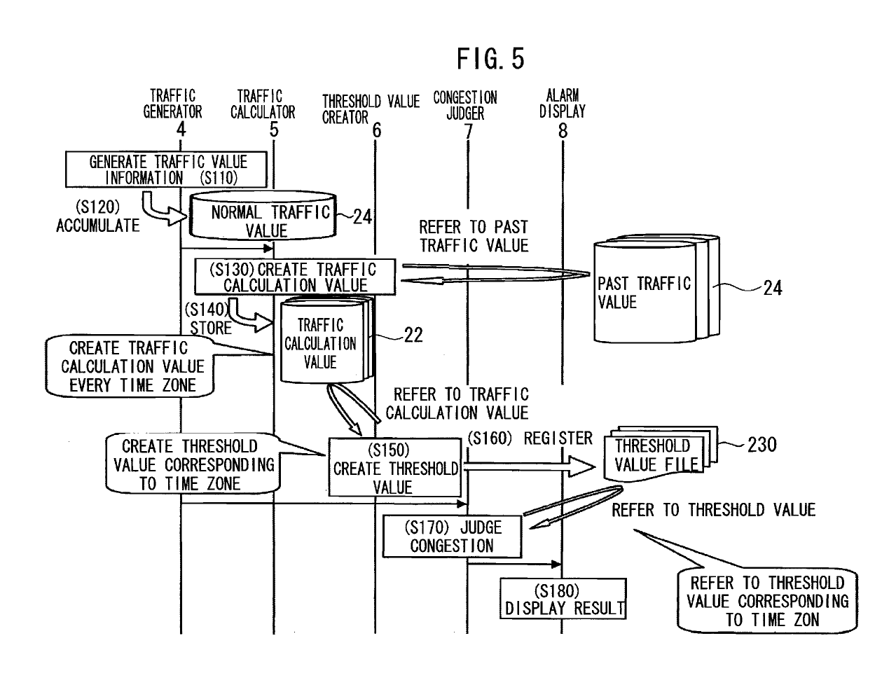

Next, a second embodiment will be described with reference to FIGS. 5 to 7. In the second embodiment, a traffic calculation value in a predetermined time zone is generated on the basis of an obtaining date (date information) of a traffic value, and a threshold value is created. The network monitoring apparatus 10 of the second embodiment contains the same construction as the network monitoring apparatus 10 of the first embodiment shown in FIG. 2, and thus the duplicative description is omitted.

In this embodiment, the traffic file transmitted from each monitoring target apparatus 30 to the network monitoring apparatus 10 contains the traffic value, the obtaining date of the traffic value, etc. Therefore, the traffic analyzer 3 analyzes where the traffic value, the obtaining date of the traffic value, etc. are put in the traffic file, and extracts the traffic value and the obtaining date of the traffic value as the item concerning the traffic.

The traffic analyzer 3 inputs the analyzed (extracted) item concerning the traffic as traffic value information into the traffic generator 4. Here, the traffic value information is information concerning the traffic value, and the obtaining date corresponding to each traffic value is associated with the traffic value.

Furthermore, the traffic item name as a calculation target, the obtaining date (a specific time zone such as every hour on a day, at a predetermined time on a predetermined day of the week or the like) of the traffic value as the calculation target, a traffic calculation value calculating method, etc. are defined in the calculation definition file 210 of this embodiment.

The traffic calculator 5 extracts the traffic value obtaining date defined in the calculation definition file 210 and the traffic value corresponding to the traffic item name as the calculation target from the traffic accumulator 24, and calculates the traffic calculation value.

Next, the operation procedure of the network monitoring apparatus according to a second embodiment will be described. FIG. 5 is a sequence diagram showing the operation procedure of the network monitoring apparatus according to the second embodiment. The description on the processing of the same operation procedure as the first embodiment is omitted.

The traffic analyzer 3 extracts the traffic value information (the traffic value and the obtaining date of the traffic value) by analyzing the content of the traffic file, and inputs the extracted traffic value information into the traffic generator 4.

The traffic generator 4 replaces the traffic value information transmitted from the traffic analyzer 3 with an XML file, a CSV file or the like, and converts traffic value information into a format which enables the traffic value information to be handled in the network monitoring apparatus 10 (S110). The traffic generator 4 inputs the XML file, the CSV file or the like with which the traffic value information is replaced into the congestion judger 7 and the traffic accumulator 24.

The traffic accumulator 24 saves the traffic value information from the traffic generator 4 (S120). In this case, the traffic accumulator 24 accumulates new traffic value information while adding the new traffic value information to the traffic value information which has been hitherto accumulated.

Next, the traffic calculator 5 refers to the traffic value information (past traffic value) of the traffic accumulator 24. In the traffic value information are stored the obtaining date of the traffic value, the traffic item name as the calculation target, etc. The traffic calculator 5 extracts the obtaining date of the traffic value, the traffic item name, the traffic calculation value calculating method, etc. from the calculation definition file 210.

The traffic calculator 5 calculates the traffic calculation value from the traffic value information by using the traffic calculation value calculating method defined in the calculation definition file 210. The traffic value used here is the traffic value, which corresponds to the traffic item name defined in the calculation definition file 210, from the traffic values accumulated in the traffic accumulator 24 and also corresponds to the obtaining date of the traffic value defined in the calculation definition file 210. In other words, the traffic calculator 5 calculates the traffic calculation value of each predetermined date (each time zone) (S130).

The traffic calculator 5 stores the traffic calculation value, the traffic item name and the obtaining date in the calculation value storage unit 22 while associating them with one another. Accordingly, the calculation value storage unit 22 preserves and stores the traffic calculation value calculated by the traffic calculator 5 (S140).

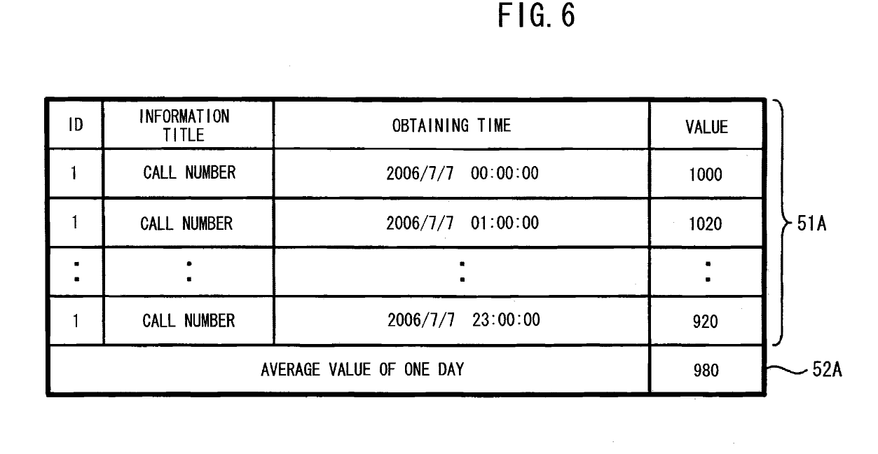

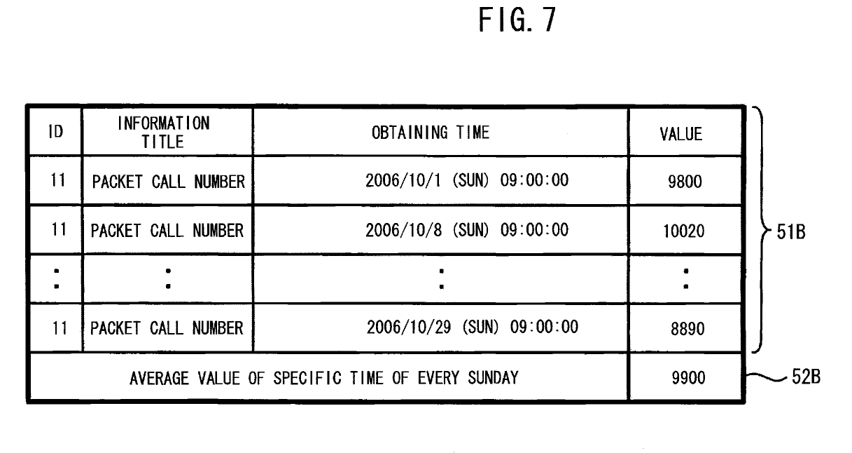

Here, the traffic value information accumulated in the traffic accumulator 24 and the construction of the traffic calculation value stored in the calculation value storage unit 22 will be described. FIGS. 6 and 7 are diagrams showing examples of the construction of the traffic value information and the traffic calculation value.

As shown in FIGS. 6 and 7, information concerning the traffic item name (“information name”), information concerning the obtaining time of the traffic value (“obtaining time”), the actual traffic value (“value”) and information for identifying the traffic item name (“ID”) are associated with one another in traffic value information 51A, 51B.

In FIG. 6, the traffic item of the traffic value information 51A is the number of calls (call number). In FIG. 7, the traffic item of the traffic value information 51B is a packet call number (the number of packet calls). Furthermore, in FIG. 6, the traffic value information 51A contains traffic values obtained every hour (on the same day). In FIG. 7, the traffic value information 51B is generated by using the traffic values obtained every week (at the same time).

The traffic calculation values generated by using the traffic value information 51A, 51B are traffic calculation values 52A, 52B. In FIG. 6, the average traffic value of one day (at 00 minute every hour) is set to the traffic calculation value 52A. In this case, the average traffic value of Jul. 7, 2006 is set as the traffic calculation value 52A. Accordingly, in the network monitoring apparatus 10, the trend of the call number at 00 minute of every hour of the monitoring target apparatus 30 can be known.

In FIG. 7, the average value of the traffic values at a specific time of a specific day of the week is set as the traffic calculation value 52B. In this case, the average value of traffic values at “09:00” of Sunday of every week is set as the traffic calculation value 52B. Accordingly, in the network monitoring apparatus 10, the trend of the packet call number at AM 9:00 of Sunday of every week of the monitoring target apparatus 30 can be known.

As described above, the traffic calculation value can be generated on the basis of the calculation definition (e.g., traffic calculation value method, obtaining date) in the calculation definition file 210. Therefore, the network monitoring apparatus 10 can know the trend of the various kinds of traffic values corresponding to the calculation definition in the calculation definition file 210.

Subsequently, the threshold value creator 6 refers to the traffic calculation value in the calculation value storage unit 22. The threshold value creator 6 creates the threshold value used for the congestion judgment by using the traffic calculation value in the calculation value storage unit 22. The threshold creator 6 creates the threshold value by adding the traffic calculation value with the congestion reference value (S150), for example. Accordingly, the threshold value creator 6 refers to the past traffic value corresponding to the obtaining date and creates the threshold value every obtaining date.

The threshold value creator 6 extracts the “alarm title” corresponding to the created threshold value from the threshold creating table 60, and associates the extracted “alarm title” with the “threshold value”. Furthermore, the threshold value creator 6 extracts the obtaining date corresponding to the created threshold value from the calculation value storage unit 22. The file in which the “threshold value” and the “alarm title” and the obtaining date are associated with one another is registered as the threshold value 230 into the threshold value file storage unit 23 by the threshold value creator 6. Accordingly, the threshold value file storage unit 23 stores the threshold file 230 in which the threshold value created by the threshold value creator 6, the alarm content corresponding to the congestion judgment and the traffic value obtaining date are associated with one another and registered (S160).

Subsequently, the congestion judger 7 refers to the threshold file 230 of the threshold value file storage unit 23. The congestion judger 7 extracts from the threshold value file storage unit 23 the threshold value corresponding to the obtaining date (the threshold value corresponding to the time zone) of the traffic value information (normal traffic value) transmitted from the traffic generator 4. The congestion judger 7 compares the traffic value of the traffic value information transmitted from the traffic generator 4 with the threshold value extracted from the threshold value file storage unit 23, and makes the congestion judgment every item as a congestion judgment target (every alarm content) (S170). Accordingly, in the congestion judger 7, the threshold value corresponding to the traffic value obtaining date (time zone) can be referred to, and the congestion judgment corresponding to the time characteristic can be made.

When the traffic value of the traffic value information is larger than the threshold value under the non-congestion state, the congestion judger 7 transmits a congestion judgment result representing a high probability of congestion to the alarm display 8. In the case of the high probability of congestion, the congestion judger 7 transmits an alarm output (generating) instruction to the alarm display 8.

On the other hand, when the traffic value of the traffic value information is smaller than the threshold value under the congestion state, the congestion judger 7 transmits the congestion judging result representing a low probability of congestion to the alarm display 8. In the case of the low probability of congestion, the congestion judger 7 transmits an alarm stop (recovery) instruction to the alarm display 8. The alarm display 8 displays a warning concerning congestion on the basis of the instruction from the congestion judger 7 (S180).

The congestion judgment may be made in consideration of a specific day (a day on which there is an event). For example, the call number increases on a day such as Christmas, Saint Valentine's Day, New Year's day or the like, and thus it is judged that there is no abnormality even when the traffic value of the traffic value information is larger than the threshold value. Furthermore, when a congestion judgment is made on a specific day, the threshold value may be set to a large value by using a large congestion reference value.

As described above, in the second embodiment, the threshold value is created by using traffic values obtained at various timings (a time zone, a day of the week, etc.). Therefore, flexible threshold value creation at various timings can be easily performed. Furthermore, the congestion judgment corresponding to the date characteristic can be performed. Still furthermore, this embodiment can be adapted to not only the time, but also the day characteristic, and thus flexible congestion judgment can be performed. Accordingly, the traffic value of the monitoring target apparatus can be easily monitored with a simple construction and the congestion can be accurately judged.

### Third Embodiment

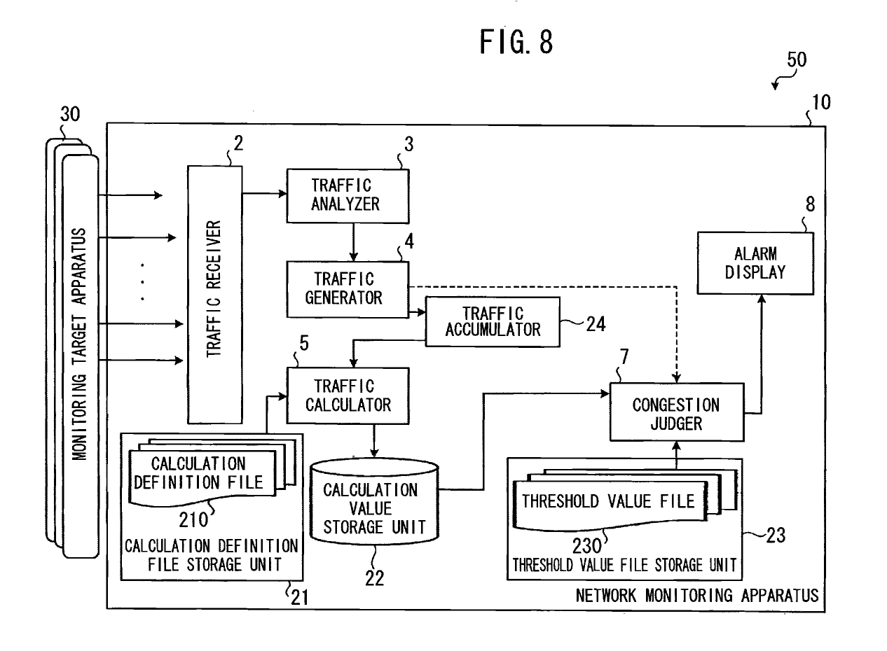

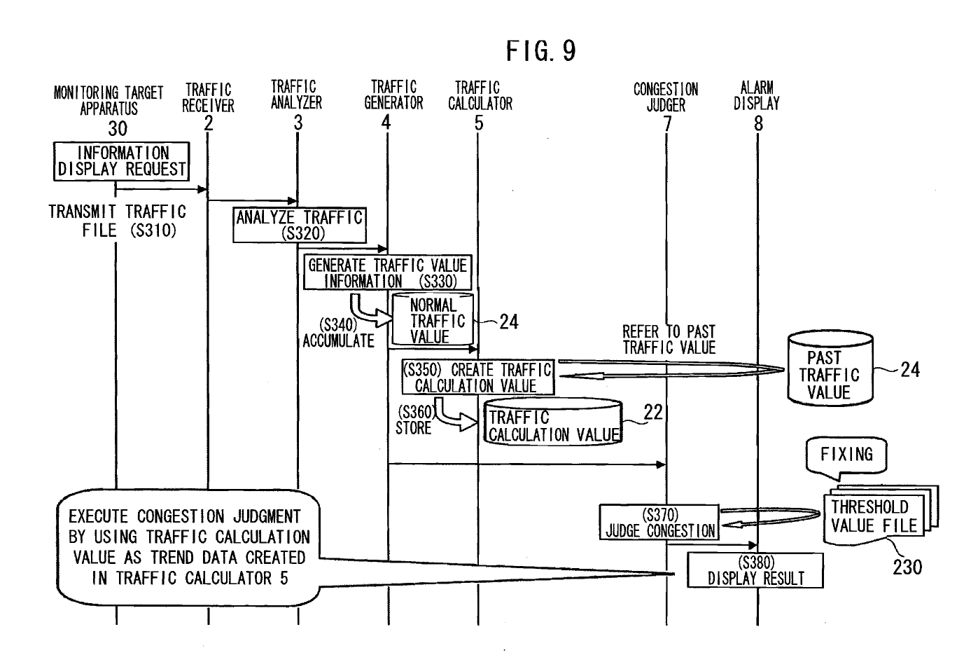

Next, a third embodiment will be described with reference to FIGS. 8 and 9. In the third embodiment, a traffic calculation value created by using saved traffic values is set as a congestion judgment target, and the traffic calculation value concerned is compared with the threshold value.

FIG. 8 is a block diagram showing the construction of a network monitoring system according to a third embodiment. The constituent elements implementing the same functions as the network monitoring system 50 of the first embodiment shown in FIG. 2 out of the respective constituent elements of FIG. 8 are represented by the same reference numerals, and the duplicative description thereof is omitted.

The network monitoring apparatus 10 of this embodiment has a traffic receiver 2, a traffic analyzer 3, a traffic generator 4, a traffic calculator 5, a congestion judger 7, an alarm display 8, a calculation definition file storage unit 21, a calculation value storage unit 22, a threshold value file storage unit 23 and a traffic accumulator 24.

The traffic receiver 2 is connected to the traffic analyzer 3, the traffic analyzer 3 is connected to the traffic generator 4, and the traffic generator 4 is connected to the traffic accumulator 24. The traffic calculator 5 is connected to the traffic accumulator 24, the calculation definition file storage unit 21 and the calculation value storage unit 22. The congestion judger 7 is connected to the calculation value storage unit 22, the threshold value file storage unit 23 and the alarm display 8.

In this embodiment, the traffic calculator 5 calculates an average value or the like of traffic values in a predetermined time zone or section, for example. The traffic calculation value calculated by the traffic calculator 5 is set as a normal traffic value (a judgment target value described in the claims) to be compared with the threshold value. In this case, the traffic calculator 5 calculates the average value or the like of traffic values in the latest ten minutes as the traffic calculation value, for example.

The congestion judger 7 compares the traffic calculation value calculated by the traffic calculator 5 with the threshold value (fixed value) preset in the threshold value file storage unit 23 to make a congestion judgment. Furthermore, in this embodiment, the threshold value file 230 in which the “alarm title” and the fixed “threshold value” are associated with each other is registered in the threshold value file storage unit 23 in advance.

Next, the operation procedure of the network monitoring apparatus according to the third embodiment will be described. FIG. 9 is a sequence diagram showing the operation procedure of the network monitoring apparatus according to the third embodiment. With respect to the processing of the same operation procedure as the first and second embodiments, the description thereof is omitted.

In the network monitoring system 50, each monitoring apparatus 30 transmits a traffic file containing a traffic value as an information display request concerning congestion to the network monitoring apparatus 10 at a predetermined timing (S310).

As in the case of the processing of the first and second embodiments, the network monitoring apparatus 10 executes reception of the traffic file, analysis of the traffic file, generation and saving of the traffic value information, calculation and storage of the traffic calculation value, etc. The processing of S320 to S360 shown in FIG. 9 corresponds to the processing of S20 to S60 of the first embodiment in FIG. 3. Furthermore, the processing of S330 to S360 shown in FIG. 9 corresponds to the processing of S110 to S140 of the second embodiment shown in FIG. 5.

In this embodiment, the traffic calculation value calculated in the traffic calculator 5 and the fixed threshold value stored in advance are compared with each other to make a congestion judgment. Therefore, it might be unnecessary to transmit the normal traffic value from the traffic generator 4 to the congestion judger 7. Furthermore, it is unnecessary to create the threshold value in the threshold value creator 6, so that the traffic calculation value stored in the calculation value storage unit 22 is not required to be transmitted to the threshold value creator 6.

In this embodiment, the traffic calculator 5 calculates (consolidates) the average value or the like of traffic values for the latest ten minutes as a traffic calculation value, for example. The traffic calculation value concerned is stored as consolidation data into the calculation storage unit 22 (S360).

After the traffic calculation value is stored in the calculation value storage unit 22 (S360), the congestion judger 7 refers to the threshold value of the threshold value file storage unit 23 (the threshold value file 230). The congestion judger 7 extracts the fixed threshold value set in the threshold value file 230 from the threshold value file 230. In this case, the congestion judger 7 extracts the threshold value corresponding to the traffic item name as a congestion judgment target.

Furthermore, the congestion judger 7 extracts the average value of traffic values in a predetermined time zone or the like (the traffic calculation value as a congestion judgment target) from the calculation value storage unit 22. The congestion judger 7 compares the traffic calculation value extracted from the calculation value storage unit 22 with the threshold value extracted from the threshold value file 230 to make the congestion judgment (S370).

When the traffic value of the traffic value information is larger than the threshold value under the non-congestion state, the congestion judger 7 transmits a congestion judgment result indicating a high probability of congestion to the alarm display 8. In the case of the high probability of congestion, the congestion judger 7 transmits an alarm output (generating) instruction to the alarm display unit 8.

On the other hand, when the traffic value of the traffic value information is smaller than the threshold value under the congestion state, the congestion judger 7 transmits a congestion judgment result indicating a low probability of congestion to the alarm display 8. In the case of the small probability of congestion, the congestion judger 7 transmits an alarm stop (recover) instruction to the alarm display 8. The alarm display 8 displays an alarm concerning congestion (an alarm concerning call number, packet call number or the like) on the basis of the instruction from the congestion judger 7 (S380).

In this embodiment, the average of traffic values in a predetermined time zone is set as the traffic calculation value. In addition, the increasing rate of the traffic value in a predetermined time zone, the total value of the traffic values in a predetermined time zone, the standard deviation of traffic values in a specific time zone to past traffic values, the median of traffic values in a predetermined time zone, the maximum value or the minimum value of the traffic values in a predetermined time zone, or the like, or any combinations thereof, may be set as the traffic calculation value. In these cases, the threshold value corresponding to each traffic calculation value may be set.

Furthermore, in this embodiment, the congestion judgment is made by using the fixed threshold value. However, as in the case of the first and second embodiments, various threshold values may be set by using past traffic calculation values by the threshold creator 6.

As described above, in the third embodiment, the traffic value from the monitoring target apparatus 30 is not directly used for the congestion judgment, but the congestion judgment is made by consolidating (averaging, for example) data through calculation processing. Therefore, the alarm can be prevented from occurring frequently due to accidental jump over the threshold value. Accordingly, only a properly and correctly required alarm can be displayed to a maintenance person.

### Fourth Embodiment

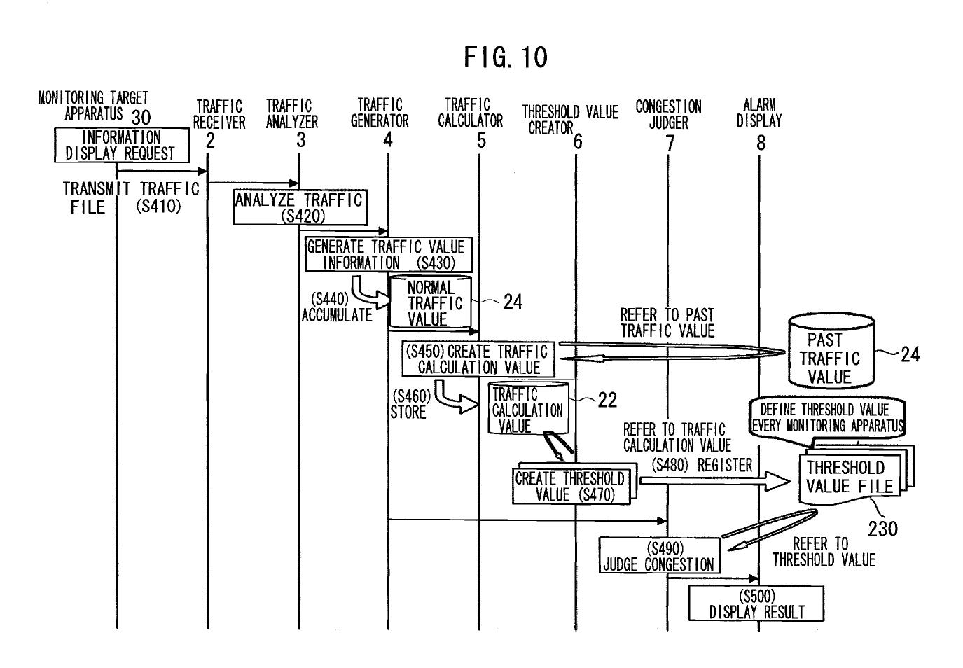

Next, a fourth embodiment will be described with reference to FIG. 10. In the fourth embodiment, the traffic calculation value is generated to make the congestion judgment for every transmission source of the traffic value (monitoring target apparatus 30). The network monitoring apparatus 10 of the fourth embodiment contains the same construction as the network monitoring apparatus 10 of the first embodiment shown in FIG. 2, and thus the duplicative description thereof is omitted.

In this embodiment, a traffic value, identification information for identifying the transmission source of the traffic value (the monitoring target apparatus 30) (hereinafter referred to as “transmission source ID”), etc. are contained in the traffic file transmitted from each monitoring target apparatus 30 to the network monitoring apparatus 10. Therefore, the traffic analyzer 3 analyzes where the traffic value and the traffic value obtaining date are input in the traffic file. Furthermore, the traffic analyzer 3 extracts the traffic value and the transmission source ID as the item concerning the traffic.

The traffic analyzer 3 inputs the item concerning the analyzed (extracted) traffic as traffic value information into the traffic generator 4. In this case, the traffic value information is information concerning the traffic value, and the transmission source ID is associated with each traffic value.

Furthermore, the traffic item name as the calculation target, the transmission source ID as the calculation target, the traffic calculation value calculating method, etc. are defined in the calculation definition file 210 of this embodiment.

The calculation method of the traffic value corresponding to the transmission source ID of the calculation target is defined in the calculation definition file 210. The traffic calculator 5 refers to the traffic value calculating method corresponding to the transmission source ID of the calculation target to extract the traffic value corresponding to the traffic item name from the traffic accumulator 24, and calculates the traffic calculation value.

Next, the operation procedure of the network monitoring apparatus according to the second embodiment will be described. FIG. 10 is a sequence diagram showing the operation procedure of the network monitoring apparatus according to the fourth embodiment. With respect to the processing of the same operation procedure as the first embodiment, the description thereof is omitted.

In the network monitoring system 50, each monitoring target apparatus 30 transmits a traffic file containing a traffic value as an information display request concerning congestion to the network monitoring apparatus 10 at a predetermined timing (S410).

The traffic receiver 2 of the network monitoring apparatus 10 receives the traffic file of each monitoring target apparatus 30 from each monitoring target apparatus 30, and inputs the traffic file into the traffic analyzer 3. The traffic analyzer 3 analyzes the traffic file and extracts the traffic value information (the traffic value, the transmission source ID) (S420), and inputs the extracted traffic value information into the traffic generator 4.

The traffic generator 4 replaces the traffic value information transmitted from the traffic analyzer 3 with an XML file, a CSV file or the like, and generates traffic value information of a format which enables the traffic value information to be handled in the network monitoring apparatus 10 (S430). The traffic generator 4 inputs the traffic value information replaced by the XML file, the CSV file or the like into the congestion judger 7 and the traffic accumulator 24.

The traffic accumulator 24 accumulates the traffic value information from the traffic generator 4 (S440). In this case, the traffic accumulator 24 adds new traffic value information to traffic value information which has been hitherto accumulated, and accumulates the addition result.

Subsequently, the traffic calculator 5 refers to the traffic value information (past traffic values) of the traffic accumulator 24. The traffic calculator 5 extracts from the traffic value information of the traffic accumulator 24 the transmission source ID, which is correspondingly defined in the calculation definition file 210 in the calculation definition file storage unit 21, the traffic item name as the calculation target, etc.

The traffic calculator 5 calculates the traffic calculation value from the traffic value information by using the calculating method of the traffic calculation value defined in the calculation definition file 210. The traffic value used here is the traffic value, which corresponds to the traffic item name defined in the calculation definition file 210, from the traffic values accumulated in the traffic accumulator 24, and also corresponds to the transmission source ID (the monitoring target apparatus 30) defined in the calculation definition file 210. In other words, the traffic calculator 5 calculates the traffic calculation value of each transmission source ID (S450).

The traffic calculator 5stores the traffic calculation value, the traffic item name and the transmission source ID while associating them with one another. Accordingly, the calculation value storage unit 22 preserves and stores the traffic calculation value calculated by the traffic calculator 5 (S460).

As described above, the traffic calculation value can be generated on the basis of the calculation definition (transmission source ID) in the calculation definition file 210. Accordingly, the network monitoring apparatus 10 can know the trend of various kinds of traffic values corresponding to the calculation definition in the calculation definition file 210.

The threshold value creator 6 refers to the traffic calculation value in the calculation value storage unit 22. The threshold value creator 6 creates the threshold value used for the congestion judgment by using the traffic calculation value in the calculation value storage unit 22. For example, the threshold value creator 6 creates the threshold value by adding the traffic calculation value with the congestion reference value. Accordingly, the threshold value creator 6 refers to the past traffic value corresponding to the transmission source ID, and creates the threshold value of each transmission source ID (a threshold value defined as another file for every monitoring target apparatus) (S470).

The threshold value creator 6 extracts the “alarm title” corresponding to the created threshold value from the threshold creating table 60, and associates the extracted “alarm title” with the “threshold value”. Furthermore, the threshold value creator 6 extracts the transmission source ID corresponding to the created threshold value from the calculation value storage unit 22. A file in which the “threshold value” is associated with the “alarm title” and the transmission source ID is registered as the threshold value file 230 in the threshold value file storage unit 23 by the threshold value creator 6. Accordingly, the threshold value file storage unit 23 registers and stores the threshold value file 230 in which the threshold value created by the threshold value creator 6 and the alarm content corresponding to the congestion judgment are associated with each other (S480).

Subsequently, the congestion judger 7 refers to the threshold value file 230 of the threshold value file storage unit 23. The congestion judger 7 extracts from the threshold value file 23 the threshold value corresponding to the transmission source ID (the threshold value corresponding to the monitoring target apparatus 30) of the traffic value information (normal traffic value) transmitted from the traffic generator 4. The congestion judger 7 compares the traffic value of the traffic value information transmitted from the traffic generator 4 with the threshold value extracted from the threshold value file storage unit 23 to make the congestion judgment for every traffic item (every alarm content) as a congestion judgment target (S490). Accordingly, in the congestion judger 7, the threshold value corresponding to the transmission source ID of the traffic value can be referred to, and the congestion judgment corresponding to the monitoring target apparatus 30 can be performed.

When the traffic value of the traffic value information is larger than the threshold value under the non-congestion state, the congestion judger 7 transmits a congestion judgment result indicating a high probability of congestion to the alarm display 8. In the case of a high probability of congestion, the congestion judger 7 transmits an alarm output (generating) instruction to the alarm display 8.

On the other hand, when the traffic value of the traffic value information is smaller than the threshold value under the congestion judger 7, the congestion judger 7 transmits a congestion judgment result indicating a low probability of congestion to the alarm display 8. In the case of a low probability of congestion, the congestion judger 7 transmits an alarm stop (recovery) instruction to the alarm display 8. The alarm display 8 displays an alarm concerning congestion on the basis of the instruction from the congestion judger 7 (S500).

In this embodiment, the congestion judgment is made for every monitoring target apparatus 30 as a transmission source. However, the monitoring target apparatuses 30 as the transmission sources may be classified into predetermined groups, and the congestion judgment may be made for every group. In this case, a threshold value is prepared for every group, and the threshold value of each group and the traffic value of each group are compared with each other to make the congestion judgment for every group. Furthermore, a group ID for identifying each group is set to each group.

As described above, the threshold value is calculated and set every monitoring target apparatus 30, and thus the congestion judgment corresponding to the characteristic of the monitoring target apparatus 30 can be performed. Accordingly, a general-purpose operation which is not dependent on the difference in type of the monitoring target apparatus 30 can be performed. Furthermore, even when the number of monitoring target apparatuses 30 increases, this embodiment can respond flexibly to the increase.

As described above, according to the fourth embodiment, the threshold value can be defined for every monitoring target apparatus 30. Therefore, when the traffic amount is varied in accordance with the set place of the monitoring target apparatus 30, the congestion judgment can be prevented from being executed on only a monitoring target apparatus 30 set at a place where the traffic amount is large. That is, the congestion judgment can be performed even when the traffic value based on the district characteristic is different in the same monitoring apparatus. Accordingly, the congestion judgment can be performed properly and accurately in accordance with each monitoring target apparatus 30 and the set place thereof.

### Fifth Embodiment

The various kinds of processing for the controlling the calculation of the traffic calculation value, the setting of the threshold value and the congestion judgment described with respect to the embodiments can be implemented by executing a prepared program with a computer system such as a personal computer, a workstation or the like. In other words, the embodiments can be implemented in computing hardware and/or software. Therefore, a computer system for executing the program having the same function as the above embodiments will be described hereunder as another embodiment.

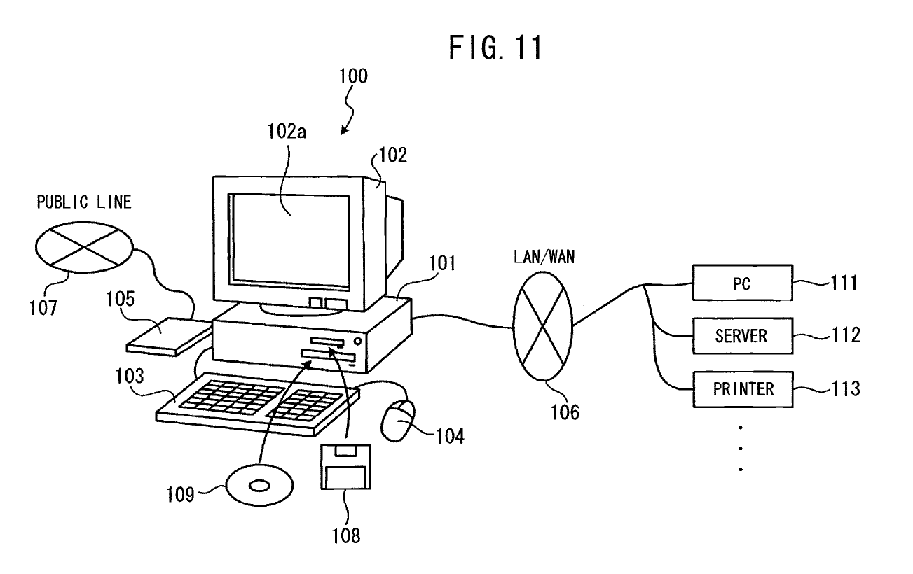

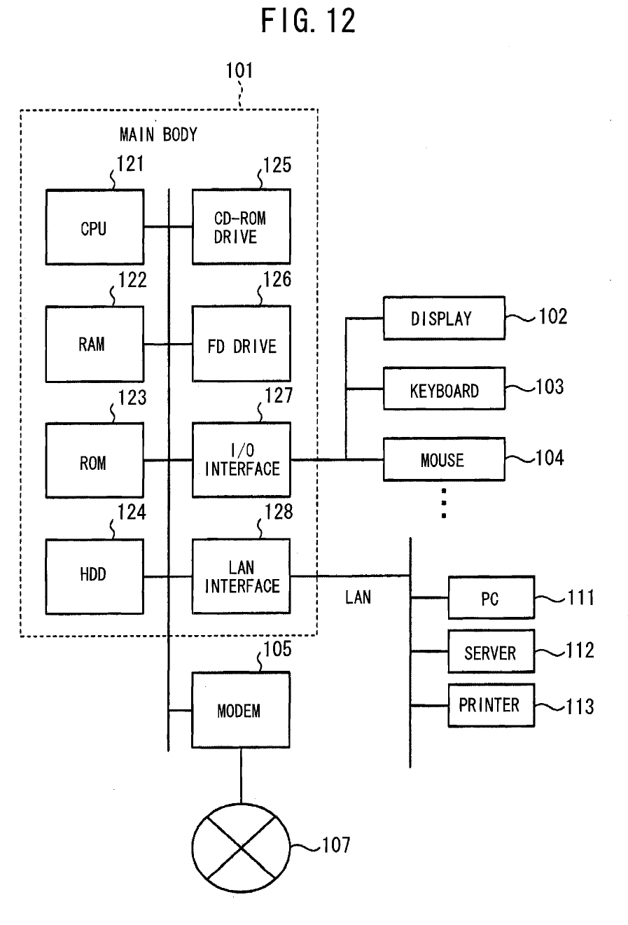

FIG. 11 is a system diagram showing the construction of a computer system according to another embodiment, and FIG. 12 is a block diagram showing the construction of a main body of the computer system. As shown in FIG. 11, the computer system 100 has a main body portion 101, a display 102, a keyboard 103 and a mouse 104. The display 102 displays information such as an image, etc. on the display screen 102a on the basis of an instruction from the main body portion 101. The keyboard 103 is used to input various kinds of information into the computer system 100. The mouse 104 is used to indicate any position on the display screen 102a of the display 102.

Furthermore, as shown in FIG. 12, the main body portion 101 of this computer system 100 has CPU 121, RAM 122, ROM 123, a hard disk drive (HDD) 124, a CD-ROM drive 125, an Flexible Disk drive (FDD) 126, a display 102, an I/O interface 127, and an LAN interface 128. The CD-ROM drive 125 receives CD-ROM 109. The FD drive 126 receives a flexible disk (FD) 108. The I/O interface 127 connects the keyboard 103 and the mouse 104. The LAN interface 128 is connected to a local area network or a wide area network (LAN/WAN) 106.

Furthermore, a modem 105 is connected to the computer system 100, and another computer system (PC) 111, a server 112, a printer 113, etc. are connected to the computer system 100 through the LAN interface 128 and the LAN/WAN 106. The modem 105 is used for connection to a public line 107 such as the Internet or the like.

The computer system 100 reads out and executes a program recorded in a predetermined recording medium to implement the same function as the embodiments described above. Here, the predetermined recording medium contains any recording medium in which a program readable by the computer system 100 is recorded. For example, the recording medium contains a flexible disk (FD) 108, CD-ROM 109, an MO disk, a DVD disk, an magnetooptical disk, and a “portable physical medium” such as an IC card or the like. In addition, the recording medium further contains a “physical medium for fixing” such as a hard disk drive (HDD) 124 which is provided outside or inside the computer system 100, RAM 122, ROM 123 or the like. Furthermore, a “communication medium” can be provided which holds a program for a short period when a program is transmitted, such as LAN/WAN 106 to which the public line 107, another computer system 111 and a server 112 are connected through the modem 105.

That is, the program of the embodiments can be recorded on computer-readable media comprising computer-readable recording media and/or communication media, such as a “portable physical medium,” or a “fixed physical medium,” as computer-readable recording media, and a “carrier wave signal” as a communication medium. For example, the computer system 100 reads the program from the recording medium as described above and executes the program to implement the same function as the embodiments described above. Furthermore, the program of the embodiments are not limited to the program being executed by the computer system 100. The embodiments may be likewise applicable to a case where the other computer system 111 or the server 112 executes the program or even when they cooperate with each other to execute the program.

As described above, the network monitoring apparatus and the network monitoring method according to the present invention are suitable for the congestion judgment of an apparatus as a traffic monitoring target. According to an aspect of an embodiment, any combinations of the described embodiment features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A network monitoring apparatus in communication with a monitoring target apparatus through a network, comprising:
a traffic receiver that receives traffic values transmitted from the monitoring target apparatus;
a traffic accumulator that accumulates the traffic values;
a traffic calculator that calculates a traffic calculation value by using the accumulated traffic values; and
a congestion judger that compares a judgment target value, corresponding to a traffic value as a congestion judgment target from the accumulated traffic values, with the traffic calculation value as a threshold value, and judges based upon the comparing whether the monitoring target apparatus is congested.

2. The network monitoring apparatus according to claim 1, further comprising:
a calculation definition file storage unit that stores calculation definition information of the traffic calculation value, wherein the traffic calculator calculates traffic calculation value on the basis of the calculation definition information stored in the calculation definition file.

3. The network monitoring apparatus according to claim 1, further comprising:
a threshold value creator that creates the threshold value by using the traffic calculation value, wherein the congestion judger judges whether the monitoring target apparatus is congested with traffic by using the judgment target value or the created threshold value.

4. The network monitoring apparatus according to claim 2, further comprising:
a threshold value creator that creates the threshold value by using the traffic calculation value, wherein
the congestion judger judges whether the monitoring target apparatus is congested with traffic by using the judgment target value or the created threshold value.

5. The network monitoring apparatus according to claim 1, further comprising a calculation definition file storage that stores calculation definition information of the traffic calculation value, wherein:
the calculation definition information contains date information concerning an obtaining date of the traffic values as a calculation target of the traffic calculation value, and
the traffic calculator calculates the traffic calculation value by using the traffic value corresponding to the traffic values date indicated by the calculation definition information.

6. The network monitoring apparatus according to claim 2, wherein
the calculation definition information contains date information concerning an obtaining date of the traffic values as a calculation target of the traffic calculation value, and
the traffic calculator calculates the traffic calculation value by using the traffic value corresponding to the traffic values date indicated by the calculation definition information.

7. The network monitoring apparatus according to claim 3, further comprising a calculation definition file storage that stores calculation definition information of the traffic calculation value, wherein:
the calculation definition information contains date information concerning an obtaining date of the traffic values as a calculation target of the traffic calculation value, and
the traffic calculator calculates the traffic calculation value by using the traffic value corresponding to the traffic values date indicated by the calculation definition information.

8. The network monitoring apparatus according to claim 4, wherein
the calculation definition information contains date information concerning an obtaining date of the traffic values as a calculation target of the traffic calculation value, and
the traffic calculator calculates the traffic calculation value by using the traffic value corresponding to the traffic values date indicated by the calculation definition information.

9. The network monitoring apparatus according to claim 1, further comprising a calculation definition file storage that stores calculation definition information of the traffic calculation value, wherein:
the calculation definition information contains identification information for identifying the monitoring target apparatus as a calculation target of the traffic calculation value, and
the traffic calculator calculates the traffic calculation value by using the traffic value corresponding to the identification information indicated by the calculation definition information.

10. The network monitoring apparatus according to claim 2, wherein
the calculation definition information contains identification information for identifying the monitoring target apparatus as a calculation target of the traffic calculation value, and
the traffic calculator calculates the traffic calculation value by using the traffic value corresponding to the identification information indicated by the calculation definition information.

11. The network monitoring apparatus according to claim 3, further comprising a calculation definition file storage that stores calculation definition information of the traffic calculation value, wherein
the calculation definition information contains identification information for identifying the monitoring target apparatus as a calculation target of the traffic calculation value, and
the traffic calculator calculates the traffic calculation value by using the traffic value corresponding to the identification information indicated by the calculation definition information.

12. The network monitoring apparatus according to claim 4, wherein
the calculation definition information contains identification information for identifying the monitoring target apparatus as a calculation target of the traffic calculation value, and
the traffic calculator calculates the traffic calculation value by using the traffic value corresponding to the identification information indicated by the calculation definition information.

13. The network monitoring apparatus according to claim 1, further comprising a calculation definition file storage that stores calculation definition information of the traffic calculation value, wherein:
the calculation definition information contains item information concerning a type of a traffic item as a traffic calculation target of the traffic calculation value, and
the traffic calculator calculates the traffic calculation value by using the traffic value corresponding to the item information indicated by the calculation definition information.

14. The network monitoring apparatus according to claim 2, wherein
the calculation definition information contains item information concerning a type of a traffic item as a calculation target of the traffic calculation value, and
the traffic calculator calculates the traffic calculation value by using the traffic value corresponding to the item information indicated by the calculation definition information.

15. The network monitoring apparatus according to claim 3, further comprising a calculation definition file storage that stores calculation definition information of the traffic calculation value, wherein:
the calculation definition information contains item information concerning a type of a traffic item as a calculation target of the traffic calculation value, and
the traffic calculator calculates the traffic calculation value by using the traffic value corresponding to the item information indicated by the calculation definition information.

16. The network monitoring apparatus according to claim 4, wherein
the calculation definition information contains item information concerning a type of a traffic item as a calculation target of the traffic calculation value, and
the calculating part calculates the traffic calculation value by using the traffic value corresponding to the item information indicated by the calculation definition information.

17. The network monitoring apparatus according to claim 5, wherein
the calculation definition information contains item information concerning a type of a traffic item as a calculation target of the traffic calculation value, and
the traffic calculator calculates the traffic calculation value by using the traffic value corresponding to item information indicated by the calculation definition information.

18. A method of monitoring a network, comprising:
saving traffic values;
calculating a traffic calculation value based upon the saved traffic values; and
using a judgment target value, corresponding to a traffic value as a congestion judgment target, from the saved traffic values and a threshold and/or the traffic calculation value as the threshold value and comparing the judgment target value with the threshold value; and
judging congestion according to the comparing.

19. A computer-readable recording medium storing a computer program judging congestion of a monitoring target apparatus by using traffic values transmitted from the monitoring target apparatus, the computer program causing a computer to execute operations comprising:
receiving traffic values transmitted from the monitoring target apparatus;
accumulating the traffic values;
calculating a traffic calculation value used for congestion judgment by using the accumulated traffic values; and
comparing a judgment target value, corresponding to a traffic value as a congestion judgment target, from the traffic values transmitted from the monitoring target apparatus with a threshold value and/or the traffic calculation value as the threshold value; and
judging congestion of the monitoring target apparatus according to the comparing.

20. A network monitoring apparatus in communication with a target apparatus, comprising:
a controller
accumulating traffic values of the target apparatus;
calculating a traffic calculation value based upon the accumulated traffic values;
comparing a traffic value from the accumulated traffic values with the traffic calculation value as a threshold value; and
judging congestion at the target apparatus based upon the comparing.
